(19) United States
(12) Patent Application Publication
(10) Pub. No.: US 2003/0046546 A1
(43) Pub. Date: Mar. 6, 2003

(54) Identifying method

(76) Inventor: Hitoshi Endo, Toyonaka-shi (JP)

Correspondence Address: NIXON & VANDERHYE P.C., 8th Floor, 1100 North Glebe Rd., Arlington, VA, 22201-4714, US

(21) Appl. No.: 10/232,717

(22) Filed: Sep. 3, 2002

(30) Foreign Application Priority Data
Sep. 4, 2001 (JP) 2001-267375

(51) Int. Cl. H04L 9/00

(52) U.S. Cl. 713/176

(57) ABSTRACT

An identifying method of the present invention is to indicate and confirm identification with ease. A communication terminal device sends communication data and a communication discrimination code, to which a certification mark to identify a user of the communication terminal device has been added, as data indicating a sender. While, an identification confirming device receives the communication data and the communication discrimination code accompanied with the communication data, so as to extract the certification mark from the communication discrimination code. Thus, the user of the communication terminal device who is the sender can indicate identification, which identifies the user, without performing a special operation. While, a receiver can confirm the identification of the sender only by extracting the certification mark from the communication discrimination code in accordance with an identification confirming device.

### FIELD OF THE INVENTION

The present invention relates to an identifying method and a device used in the method, a program which realizes the method, and a computer-readable storage medium storing the program, and specifically relates to an identifying method, a sending device, a receiving device, a communication relaying device, an identification program, and a computer-readable storage medium storing the identification program.

### BACKGROUND OF THE INVENTION

Conventionally, upon identifying oneself, (a) cards storing official private (personal) data such as various kinds of licenses, a national insurance card, and a seal registration card that have been registered to public institutions, and (b) cards storing unofficial private data such as a credit number and a bank account number registered to private institutions are used.

For example, as to a credit card (including a debit card), upon purchasing an article (product), a purchaser hands the credit card to a seller at a checkout counter, and the seller examines the card and inputs a price of the article, and the purchaser confirms an account of the article so as to sign his/her name by himself/herself, so that payment is completed. In this way, identification with use of a credit card is widely performed as one of methods for paying in face-to-face sales.

A card which stores the private data is typically made of paper or plastic, and private data is written or impressed on a surface of the card, or the private data is stored using electromagnetic tape or IC. Further, there is a card having a facial portrait of a user on its surface.

However, according to the above-mentioned method, it is difficult to realize steps the confirmation whether various kinds of data disclosed by the seller and the purchaser is exact or not, so that there occurs risk in warranting purchase and sale etc., or it is substantially impossible to warrant purchase and sale etc. Thus, troubles concerning identification occur one after another.

For example, as to most of cards, it is actual that the identification is acknowledged based only on a signature of the purchaser. Moreover, there are such cases that: if someone possesses a credit card, he/she can make payment using the credit card regardless of whether the credit card is actually his/her possessions or not. In this way, current credit cards and cash cards, except for cards having facial portraits thereon, can be easily used by person other than the identical person.

Furthermore, with remarkable progress in recent information technology, business has been performed in the Internet. Currently, most of the business in the Internet is a direct business transaction between the purchaser and the seller. However, in most of the cases, the business in the Internet is performed between unacquainted people, and an identifying method for the business transaction has not been arranged sufficiently. Thus, there occur many troubles and crimes such that: the article is not delivered, or an inferior article is delivered, or payment is not made, and the like. Further, due to the insufficient arrangement of the identifying method, it is often that victims of the problem have to give up fair transaction.

In order to prevent such trouble, the seller of the article often requires the purchaser to input private data such as name, an address, and a credit card number to an application form. Thus, the purchaser inputs the private data to the application form each time required so as to identify himself/herself. However, the input of the private data is a bother for the purchaser, and sending the private data such as a credit card number in the Internet is not preferable in terms of security. While, the seller discloses data on himself/herself so as to show that his/her site is trustworthy.

Furthermore, Japanese Unexamined Patent Publication No.36000/2000 (Tokukai 2000-36000) (Publication date: Feb. 2, 2000) discloses the following technique: there is prepared a neutral observer between the seller and the purchaser so as to record the content of contraction established between the seller and the purchaser, so that troubles brought about between the seller and the purchaser are prevented, thus performing business in a stable manner.

However, even though the foregoing technique is applied, it is impossible to prevent troubles brought about by disclosure of fake private data. That is, it is extremely difficult to confirm whether the private data is real one or not, so that the neutral observer has to take great risk in warranting the business transaction completely. Accordingly, it is predicted that procedures the seller and the purchaser have to perform will be complicated.

In this way, there are currently few methods for confirming whether various kinds of data disclosed by the seller and the purchaser are exact or not even in the business in the Internet, so that it is substantially impossible to warrant purchase and sale, or warranting purchase and sale is extremely risky. Therefore, there is such misgiving that markets are not expanded in the Internet for fear of troubles or crimes.

### SUMMARY OF THE INVENTION

The present invention is made so as to solve the foregoing problems, and its object is to provide an identifying method by which identification can be easily indicated and confirmed, and to provide a sending device, a receiving device, and a communication relaying device. Further, the object of the present invention provides an identification program for executing the identifying method and a computer-readable storage medium storing the program.

In order to achieve the foregoing object, the identifying method of the present invention includes the steps of: performing a certification mark adding process for adding a certification mark, which identifies a user of a sending device, to a communication discrimination code that the sending device sends as data indicating a sender; and performing a certification mark extracting process for extracting the certification mark from the communication discrimination code that has been received by a receiving device.

According to the method, the receiving device receives the communication discrimination code, to which the certification mark for identifying the user of the sending device has been added, as data indicating the sender. Here, examples of the communication discrimination code include a cellular phone number and an e-mail address (electronic mail in the Internet). Further, alpha-numerals and symbols can be used as the certification mark. Note that, the addition of the certification mark to the communication discrimination code may be performed by the sending device or by a device for relaying communication between the sending device and the receiving device.

Thus, the user of the sending device who is a sender can indicate the identification, which identifies the user, without performing a special operation. While, the receiver on the side of the receiving device can confirm the identification of the sender only by extracting the certification mark from the communication discrimination code that has been received. Thus, the identification can be easily indicated and confirmed.

The method can be used for business transaction, various kinds of contract, and membership registration that are performed by using the Internet or a telephone. Concretely, since a seller of an article can receive data such as a credit card number of a purchaser in combination with the communication discrimination code to which the certification mark has added, it is possible to confirm the identification of the purchaser by extracting and checking the certification mark. Further, if the reliable certification mark has been added to the communication discrimination code, it is possible not only to perform the business transaction in accordance with the obtained data with a safe conscience, but also to readily cope with problems in a case where fraud is brought about.

Furthermore, under the condition that an examination is required in accordance with official private data such as a driver's license and a national insurance card upon adding the certification mark, it is possible to render the certification mark reliable. Further, by using a new communication discrimination code to which the certification mark has been added, it is possible to realize reliable identification. Therefore, it is possible not only to simplify a procedure such as a business transaction and contraction, but also to decrease risk. It is further possible to prevent cybercrime.

Note that, as the certification mark, a symbol which can be displayed in a typical display device may be used, or a code, which cannot be displayed but can be discriminated upon processing data, may be used. Further, it is possible to assign different symbols according to ages of the users of the sending device. Further, plural kinds of certification marks may be stored in a single sending device, so that the user can select one certification mark so as to send a communication discrimination code having the selected certification mark.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a diagram schematically showing an identifying method according to an embodiment of the present invention.

FIG. 2 is a diagram showing an example of a communication discrimination code and an identification code to which a certification mark used in the identifying method shown in FIG. 1 has been added.

FIG. 3 is a diagram showing an example of a network for executing the identifying method shown in FIG. 1.

FIG. 4 is a block diagram schematically showing an arrangement of a communication terminal device and an identification registering device shown in FIG. 3.

FIG. 5 is a block diagram schematically showing another arrangement of the communication terminal device and the identification registering device shown in FIG. 3.

FIG. 6 is a diagram showing a procedure in which the communication identification code having the certification mark is stored in the communication terminal device shown in FIG. 4 and FIG. 5.

FIG. 7 is a diagram showing another procedure in which the communication identification code having the certification mark is stored in the communication terminal device shown in FIG. 4 and FIG. 5.

FIG. 8 is a diagram showing a further procedure in which the communication identification code having the certification mark is stored in the communication terminal device shown in FIG. 4 and FIG. 5.

FIG. 9 is a diagram showing yet another procedure in which the communication identification code having the certification mark is stored in the communication terminal device shown in FIG. 4 and FIG. 5.

FIG. 10 is a flow chart showing how the communication identification code to which the certification mark has been added is stored in the communication terminal device shown in FIG. 4 and FIG. 5.

FIG. 11 is a flow chart showing how the communication identification code to which the certification mark has been added is updated in the communication terminal device shown in FIG. 4 and FIG. 5.

FIG. 12 is a diagram showing a procedure in which a certification mark is added to the communication discrimination code accompanied with communication data sent from the communication terminal device shown in FIG. 3.

FIG. 13 is a diagram showing another procedure in which a certification mark is added to the communication discrimination code accompanied with communication data sent from the communication terminal device shown in FIG. 3.

FIG. 14 is a block diagram schematically showing an arrangement of a communication relaying device which realizes the procedures shown in FIG. 12 and FIG. 13.

FIG. 15 is a flow chart showing a procedure in which data is stored in the communication terminal device shown in FIG. 5.

FIG. 16 is a diagram showing a procedure of business transaction in which the identifying method shown in FIG. 1 is used.

FIG. 17 is a diagram showing another procedure of business transaction performed by using the identifying method shown in FIG. 1.

FIG. 18 is a diagram showing a procedure of contract made by using the identifying method shown in FIG. 1.

FIG. 19 is a diagram showing another procedure of contract made by using the identifying method shown in FIG. 1.

FIG. 20 is a diagram showing a procedure of intermediary warranty service performed by using the identifying method shown in FIG. 1.

FIG. 21 is a flow chart showing how the intermediary warranty service is performed by using the identifying method shown in FIG. 1.

FIG. 22 is a diagram showing another procedure of intermediary warranty service performed by using the identifying method shown in FIG. 1.

FIG. 23 is a flow chart showing a procedure for preventing reception of an unsolicited mail by using the identifying method shown in FIG. 1.

### DESCRIPTION OF THE EMBODIMENTS

An embodiment of the present invention is described as follows.

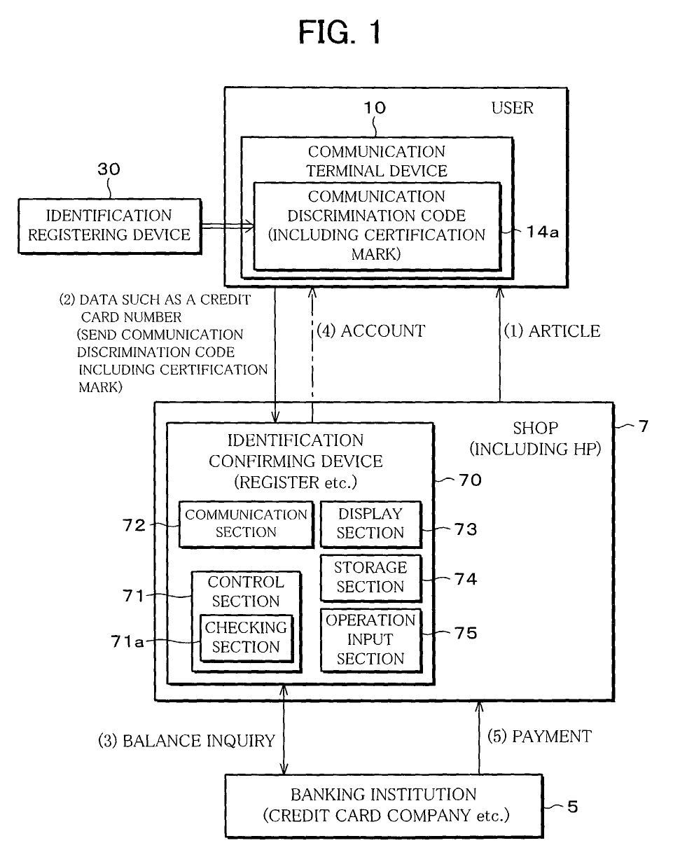

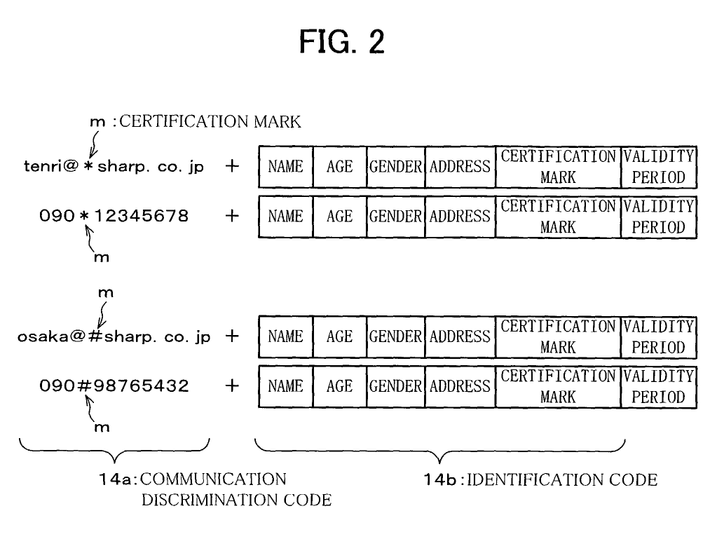

First, referring to FIG. 1 and FIG. 2, an identifying method according to the present embodiment is schematically described.

As shown in FIG. 1, in performing business transaction ((1)) such as shopping at a shop 7, a purchaser of an article (product) sends data required in payment such as a name and a credit card number ((2)) from a communication terminal device 10 to an identification confirming device 70 such as a cash register of the shop 7. In the shop 7, the identification confirming device 70 makes a balance inquiry to a banking institution 5 such as a credit card company ((3)) based on data sent from the communication terminal device 10. If a result of the balance inquiry shows no problems, the shop 7 issues an account ((4)) so as to complete the business transaction with the purchaser. This account is also sent from the identification confirming device 70 to the communication terminal device 10. Note that, payment is made with respect to the shop 7 via the banking institution 5 ((5)) in the same way as conventional business transaction. Further, examples of the shop 7 include not only actual shops but also virtual shops (hereinbelow sometimes referred to as HP (home page)) in the Internet.

Here, data that the purchaser is required to disclose upon payment is stored in the communication terminal device 10 in advance. Further, when the data is sent from the communication terminal device 10, a communication discrimination code 14a which is a discrimination code for discriminating each communication terminal device 10 is sent at the same time. Examples of the communication discrimination code 14a include (a) the communication terminal device 10's telephone number in a case where a cellular phone is used as the communication terminal device 10 and (b) the communication terminal device 10's e-mail address in a case where an e-mail terminal is used as the communication terminal device 10.

Particularly, as shown in FIG. 2, a certification mark (certification code) m of an alpha-numeral etc. is added to the communication discrimination code 14a in the communication terminal device 10. The certification mark m is added to the communication discrimination code 14a by a certification mark adding institution only in a case where a user of the communication terminal device 10 passes an examination performed by an examination institution so as to determine whether or not the user should receive identification service. For example, “*” is added as the certification mark m to a right side of “@ (at mark)” or “090 (dialing code)” in a case where the user is an adult and his/her identification has been registered based on official private (personal) data. That is, the communication discrimination code 14a is the same as a conventional telephone number or an e-mail address before being registered, but the communication discrimination code 14a is changed so that the certification mark m is added after registration application for the identification service is acknowledged as a result of the examination.

In a case of FIG. 1, the communication discrimination code 14a to which the certification mark m has been added is written in the communication terminal device 10 in advance by an identification registering device 30 of the certification mark adding institution.

Note that, the communication discrimination code 14a to which the certification mark m has been added is used to identify the user of the communication terminal device 10. Thus, in a case where the communication discrimination code 14a to which the certification mark m has been added is stored in the communication terminal device 10, a sending medium for sending data required in payment is not necessarily identical with a sending medium based on the communication discrimination code 14a. Of course, it is more preferable that the sending medium is identical as an identifying method. That is, in a case of sending data from a communication terminal device 10 which has been registered not as a cellular phone but as an e-mail terminal, an e-mail address to which the certification mark m has been added is sent at the same time via the cellular phone line, so that it is also possible to indicate his/her identification.

While, the identification confirming device (receiving device) 70 includes: a control section 71 for controlling the entire device; a communication section (receiving means) 72 for performing communication with devices such as the communication terminal device 10 and the banking institution 5; a display section 73 for displaying various kinds of data; a memory section 74 for storing the various kinds of data; and an operation input section 75 operated by an operator. The respective sections enable the identification confirming device 70 to function as a conventional register.

Furthermore, in the identification confirming device 70, the control section 71 includes a checking section 71a (extracting means) which extracts the certification mark m included in the communication discrimination code 14a (address etc. of a sender) so as to judge its validity when receiving communication from other devices. In the control section 71, it is possible to display received correspondence including the communication discrimination code 14a, in the display section 73 in combination with a judging result on the certification mark m that has been given by the checking section 71a.

As described above, in the identifying method, the examination institution examines an application sent from the user of the communication terminal device 10, and the certification mark adding institution adds the certification mark m to a telephone number or an e-mail address of the communication terminal device 10. Thus, it is possible to send the telephone number or the e-mail address to which the certification mark m has been added as data for specifying a sender who has transmitted the correspondence from the communication terminal device 10. Note that, the examination institution includes a third party such as an official institution 4 and a warranty service company 6, a cellular phone company 2, and a provider 3. Further, the certification mark adding institution includes a communication company such as the cellular phone company 2 and the provider 3 for performing communication based on the communication terminal device 10.

Thus, according to the identifying method, the shop 7 can obtain data such as a credit card number from the communication terminal device 10 having the certification mark m which indicates that the user of the communication terminal device 10 has passed the examination performed by the examination institution. Therefore, the shop 7, the seller, can confirm identification of the user, the purchaser, of the communication terminal device 10 with ease, so that the seller can perform business transaction securely. Further, also the purchaser has only to send the data such as a credit card number from the communication terminal device 10, so that it is easy to indicate his/her identification, and a signature etc. is not required. Further, it is possible to store the account in the communication terminal device 10 as history. In this manner, when the certification mark m is extracted by the identification confirming device 70 of the shop 7, it is not required to send the communication discrimination code 14a to the banking institution 5 unlike the case where the certification mark m is extracted at the banking institution 5 for example, so that it is possible to confirm the identification more quickly and securely.

Note that, in a case where payment is made at an actual shop, it is preferable to use a short distance radio communication such as Bluetooth so as to perform communication between the communication terminal device 10 and the identification confirming device 70. Further, the shop 7 only may confirm the certification mark m, but the banking institution 5 may confirm the certification mark m after the identification confirming device 70 sent the certification mark m to the banking institution 5. That is, when the identification confirming device 70 of the shop 7 receives the correspondence, the communication discrimination code 14a etc. is sent to the banking institution 5 so as to extract the certification mark m at the banking institution 5. According to the arrangement, it is not necessary to extract the certification mark m at the shop 7, and it is possible to simplify the arrangement of the identification confirming device 70 of the shop 7. Thus, it is possible to realize the identifying method of the present invention easily. Moreover, the identifying method is effective also with respect to an account for service in which it is not necessary to make a member card in the shop 7 or to interact with the banking institution 5.

The identifying method is detailed as follows.

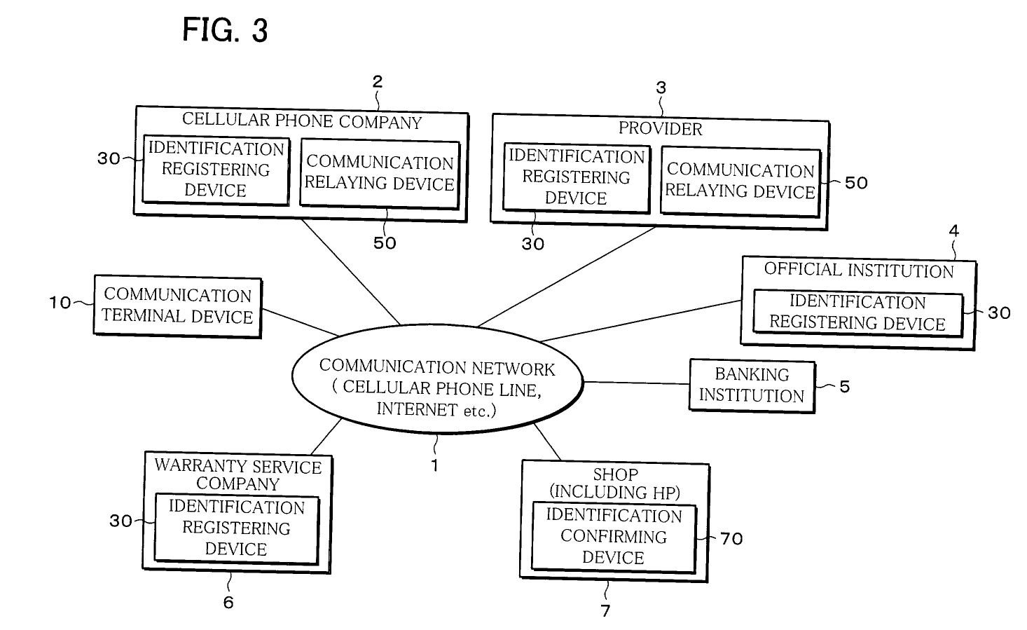

First, as shown in FIG. 3, the communication terminal device 10 is a communication terminal such as a cellular phone and an Internet terminal, and it is connected to a network 1 such as a cellular phone line or the Internet. The communication terminal device 10 can perform communication with the cellular phone company 2, the provider 3, the official institution 4, the banking institution 5, the warranty service company 6, and the shop 7 via the network 1. Note that, the cellular phone company 2, the provider 3, the official institution 4, and the warranty service company 6 function as the examination institution or the certification mark adding institution as detailed later.

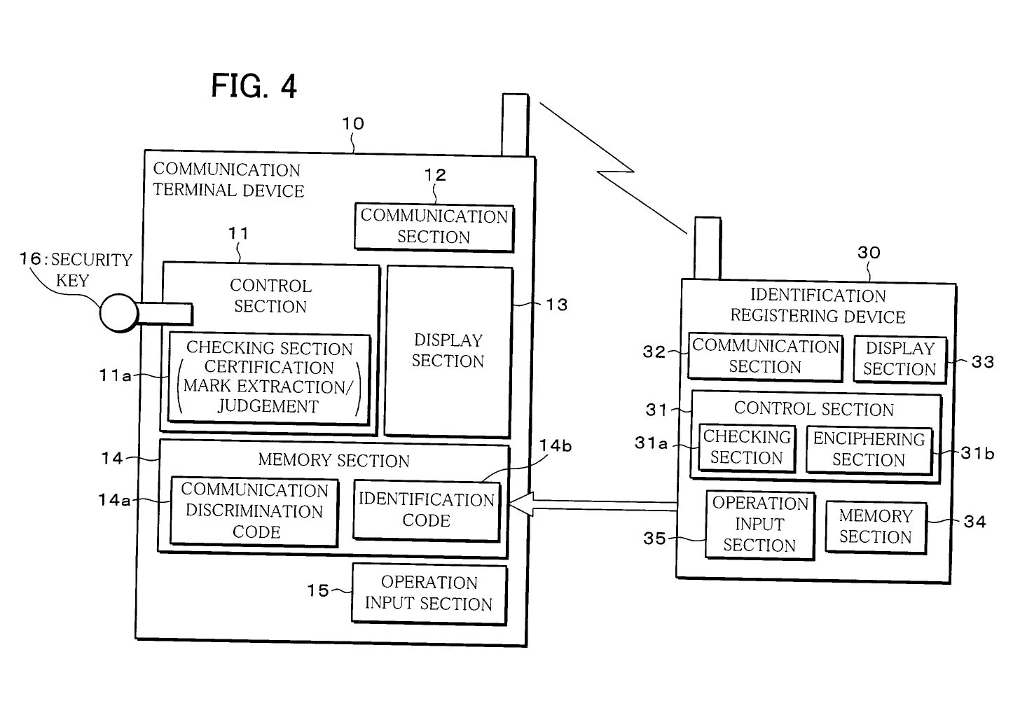

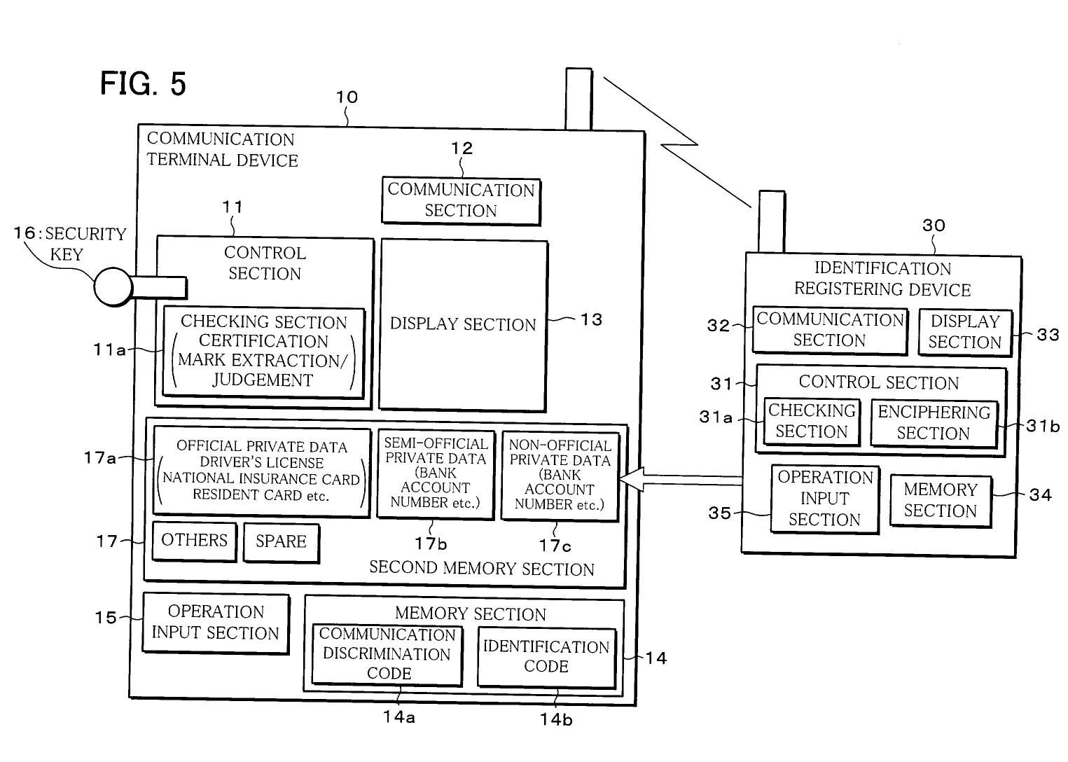

Next, FIG. 4 and FIG. 5 are block diagrams schematically showing an arrangement of the communication terminal device 10 and the identification registering device 30.

As shown in FIG. 4, the communication terminal device (sending device, receiving device) 10 includes at least: a control section (sending means) 11 for controlling the entire device; a communication section (sending means) 12 for performing communication with external devices; a display section 13 for displaying various kinds of data; a memory section (memory means) 14; an operation input section 15 operated by a user; and a security key (acknowledging means) 16. The communication terminal device 10 functions as a conventional terminal device due to the control section 11, the communication section 12, the display section 13, the memory section 14, and the operation input section 15.

Particularly, when the control section 11 sends correspondence, the control section 11 sends the communication discrimination code 14a read out from the memory section 14 at the same time. This is similar to the case where the communication terminal's telephone number or e-mail address is sent at the same time when the communication terminal sends data.

Further, the security key 16 is a mechanical or electrical key, and an additional part, which is detachable with respect to the communication terminal device 10. The security key 16 acknowledges the user of the device, and functions as acknowledging means for forbidding the use of the sending device by person other than the regular user. That is, the control section 11 sends the communication discrimination code 14a to which the certification mark m has been added only in a case where the security key 16 is installed so as to unlock a security lock. Of course, the security key may entirely restrict the use of the communication terminal device 10. Note that, as a security function of the communication terminal device 10, besides the security key 16, there may be added a discriminating function such as a password, finger print recognition, and voice recognition. In this way, it is desirable that a plurality of security functions are set.

Thus, it is possible to prevent such a trouble that other people pretends to be a regular user so as to perform communication via the communication terminal device 10 by using the communication discrimination code 14a to which the certification mark m has been added.

Furthermore, in the communication terminal device 10, the control section 11 includes the checking section 11a which extracts the certification mark m included in the communication discrimination code 14a (address etc. of a sender) so as to judge its validity when receiving communication from other devices. In the control section 11, it is possible to display received correspondence including the communication discrimination code 14a, in the display section 13 in combination with a judging result on the certification mark m that has been given by the checking section 11a.

Here, as shown in FIG. 2, the memory section 14 stores a telephone number or an e-mail address, which is a discrimination code of the communication terminal, as the communication discrimination code 14a. If the communication discrimination code 14a is registered in the identification service, the certification mark m is added to the communication discrimination code 14a. For example, in a case where an adult is registered based on official private data, “*” is added as the certification mark m. In a case where underage person is registered based on official private data, “#” is added as the certification mark m. Note that, a code of the certification mark m, length of an added code, and a position in which the code is added can be arbitrarily selected.

Furthermore, the memory section 14 can store the identification code 14b for complementing the certification mark m so that the communication discrimination code 14b corresponds to the identification code 14a. Examples of the content of the identification code 14b include a name, age, gender, an address of the user, a certification mark, a name of an examination institution, a name of a certification mark adding institution, classification of private data on which the identification is based, a lank of the identification, and a period of validity. Note that, data stored as the identification code 14b can be arbitrarily set by the examination institution and/or the certification adding institution. Further, the identification code 14b is stored in the memory section 14 by the examination institution and/or the certification adding institution. Further, in order to send the identification code 14b, as shown in FIG. 2, a mark and an alpha-numeric code may be sent so as to follow the communication discrimination code 14a, or a telephone number and an e-mail address may be partially changed as in the certification mark m. In this manner, not only the certification mark m but also the identification code 14b may be added to the communication discrimination code 14a so as to be sent. When the correspondence is received, the identification code 14b and the certification mark m are extracted. Thus, it is possible to identify oneself more steadily by indicating the identification code 14b that complements the certification mark m.

Note that, in the communication terminal device 10, the certification mark m and the identification code 14b may be sent so as not to be displayed (so as to be ignored) in a typical display device (viewer, browser). In this case, the identification confirming device 70 and the communication terminal device 10 may extract the certification mark m and the identification code 14b by means of the checking section 71a and the checking section 11a so as to substitute with a code that can be displayed in the display section 73 and the display section 13 for example. The identification registering device 30 enables similar display.

Furthermore, the communication terminal device 10 also can receive plural kinds of identification service. For example, plural kinds of certification marks m and identification codes 14b may be assigned to a single telephone number. In this case, the user can choose which certification mark m is to be sent. Note that, it is possible to send plural kinds of certification marks m at the same time. Adversely, it is also possible to request the specific certification mark m that the shop 7 etc. want to obtain by specifying the examination institution etc. Of course, the user can set the communication terminal device 10 so that only a telephone number and an e-mail address are sent in the same manner as in the conventional method, that is, neither the certification mark m nor the identification code 14b are sent.

Furthermore, as shown in FIG. 5, the communication terminal device 10 may be provided with a second memory section 17 for storing private data on which the identification is based (that is, private data examined upon application for addition of the certification mark m). Examples of data stored in the second memory section 17 include (a) official private data 17a such as a driver's license, a national insurance card, and a resident card, (b) semi-official private data 17b such as an account number, and (c) unofficial private data 17c such as a using history of the banking institution 5 and a facial portrait on a credit card. Note that, such private data may be accumulated as a copied image obtained by copying the original. Further, there may be provided an area for storing private data other than the foregoing private data in the second memory section 17 regardless of the certification mark m.

The official private data 17a, the semi-official private data 17b, and the unofficial private data 17c are stored in the second memory section 17 mainly in a case where an examination is performed by the official institution 4 or the warranty service company 6 as described later, or in a case where the certification mark m is stored by the cellular phone company 2 or the provider 3.

Further, the private data stored in the second memory section 17 can be displayed in the display section 13, in combination with the communication discrimination code 14a to which the certification mark m has been added, or regardless of the communication discrimination code 14a. Thus, it is possible to show and to display a copy image of the driver's license, on which the identification is based, in the display section 13 of the communication terminal device 10.

Further, the communication discrimination code 14a and the identification code 14b stored in the memory section 14, and the official private data 17a, the semi-official private data 17b, and the unofficial private data 17c in the second memory section 17 are stored so as not to be changed by the user, and only to be charged by the examination institution and the certification mark adding institution. That is, in the storage section 14 and the second storage section 17, the writing of the communication discrimination code only by a predetermined competent (qualified) person is allowed. Thus, it is possible to secure the reliability of the identification. Further, the private data is basically enciphered so as to be stored. Thus, even though the communication terminal device 10 is lost or stolen, it is possible to secure the private data. Note that, known technique can be suitably selected in enciphering.

Furthermore, the memory section 14 and the second memory section 17 may be arranged so that they are detachable with respect to the communication terminal device 10 as the security key 16 is. Besides, the memory section 14 and the second memory section 17 may be integrally provided on the security key 16. Of course, it is possible to suitably set combination of (a) data selected from those data and (b) a memory selected from those memories.

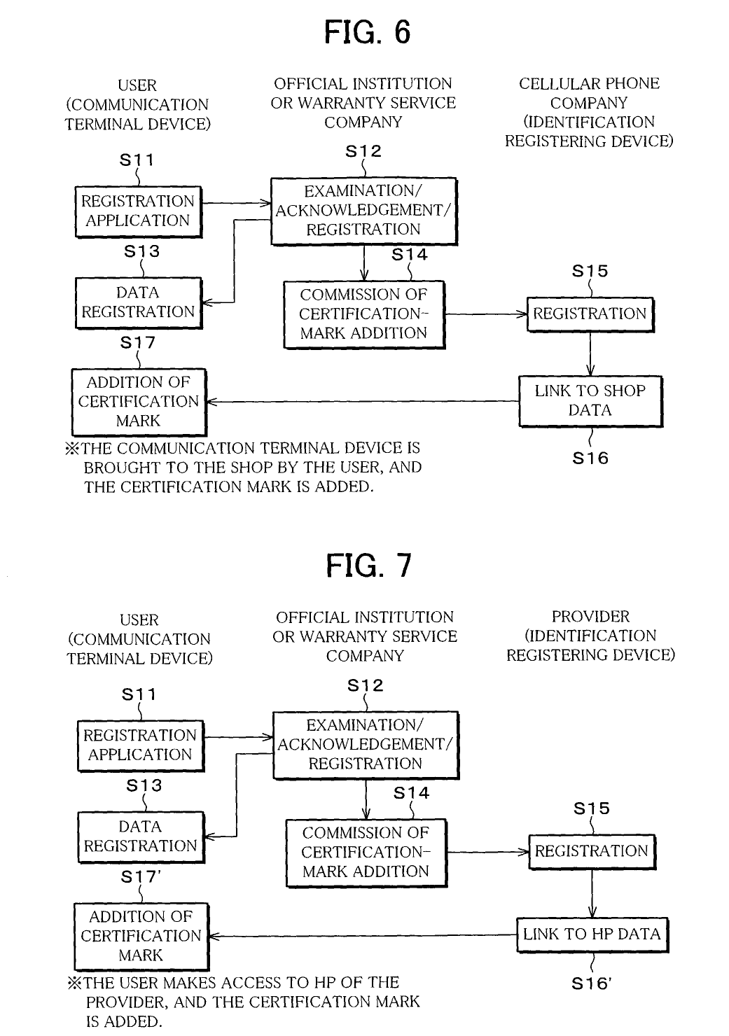

Next, referring to FIG. 6 to FIG. 15, description is given on (a) the examination performed by the examination institution and (b) procedure in which the certification mark adding institution adds the certification mark m to the communication terminal device 10.

First, by using FIG. 6 and FIG. 7, description is given on the following case: the official institution 4 or the warranty service company 6 examines an application of the user of the communication terminal device 10 as the examination institution, and the cellular phone company 2 or the provider 3 adds the certification mark m as the certification mark adding institution. Note that, the warranty service company 6 can warrant the identification for profit, or can warrant the identification as customer service performed by ordinary companies such as various kinds of insurance companies at low price or free of charge. Further, in the case where the identification warranty service is performed as the customer service, it is possible to change the certification mark m according to a period for business transaction, and it is also possible to provide such additional service that: monetary warranty brought about in the business transaction is also added, or the warranty content is enlarged.

As shown in FIG. 6, if the user of the communication terminal device 10 makes an application for adding the certification mark m to cellular phone number (S11), the official institution 4 or the warranty service company 6 examines the application (S12). In a case where the official institution 4 or the warranty service company 6 acknowledges the application, a cellular phone company 2 is asked to add the certification mark m (S14). The cellular phone company 2 registers the communication terminal device 10 to which the cellular phone company 2 has been asked to add the certification mark m (S15), and the cellular phone company 2 instructs a shop nearest to the user to store the telephone number, to which the certification mark m has been added, in the communication terminal device 10 (S16). The shop stores the telephone number to which the certification mark m has been added (communication discrimination code 14a) in the memory section 14 of the communication terminal device 10 brought by the user (S17).

Furthermore, as shown in FIG. 7, if the user of the communication terminal device 10 makes an application for adding the certification mark m to e-mail address (S11), the official institution 4 or the warranty service company 6 examines the application (S12). In a case where the official institution 4 or the warranty service company 6 acknowledges the application, a provider 3 is asked to add the certification mark m (S14). The provider 3 registers the communication terminal device 10 to which the provider 3 has been asked to add the certification mark (S15), and the provider 3 makes a home page to store the e-mail address, to which the certification mark m has been added, in the communication terminal device 10 (S16′). When the user makes access from the communication terminal device 10 to the home page prepared by the provider 3, the e-mail address to which the certification mark m has been added (communication discrimination code 14a) is stored in the memory section 14 based on a process that has been set in the home page (S17′).

Here, as shown in FIG. 4, it is possible to use the identification registering device 30 so as to store the communication discrimination code 14a, to which the certification mark m has been added by the cellular phone company 2 or the provider 3, in the memory section 14 of the communication terminal device 10. Further, the identification registering device 30 can store (a) the communication discrimination code 14a to which the certification mark m has been added and (b) identification code 14b at the same time.

The identification registering device 30, as shown in FIG. 4, includes: a control section 31 for controlling the entire device; a communication section 32 for performing communication with external devices; a display section 33 for displaying various kinds of data; a memory section 34 for storing the various kinds of data; and an operation input section 35 operated by an operator.

In accordance with a received telephone number or e-mail address, the checking section 31a judges whether or not a communicating opponent is the communication terminal device 10 to which the cellular phone company 2 or the provider 3 has been asked to add the certification mark m.

The memory section 34 can store entire data concerning the identification service. Examples of the data include a telephone number or an e-mail address before the certification mark m has not been added to, a name of the user, age, gender, an address, a name of the examination institution, application date, date of application acknowledgement, classification of the private data on which the identification is based, the certification mark, lank of the identification, a validity period, and a name of the certification mark adding institution. Note that, the data is obtained when the examination institution asks the cellular phone company 2 or the provider 3 to add the certification mark m.

The enciphering section 31b enciphers data that should be stored in the memory section 14 or the second memory section 17 of the communication terminal device 10.

In accordance with the data stored in the memory section 34, the control section 31 makes the communication discrimination code 14a which includes the certification mark m and the identification code 14b, and enciphers the communication discrimination code 14a and the identification code 14b, then transmits the communication discrimination code 14a and the identification code 14b via the communication section 32 to the communication terminal device 10, so as to store the communication discrimination code 14a and the identification code 14b in the memory section 14.

Note that, the examination institution causes the identification registering device 30 (a) to accumulate the private data, that is used when the examination is performed, in the memory section 34 and (b) to store the data in the second memory section 17 of the communication terminal device 10 (S13). Similarly, in the examination institution, the identification code 14b may be stored in the memory section 14 of the communication terminal device 10. Further, data that should be accumulated in the memory section 34, that is, a database of the identification service may be built in the examination institution such as the official institution 4 and the warranty service company 6, or may be built in the certification mark adding institution such as the cellular phone company 2 and the provider 3.

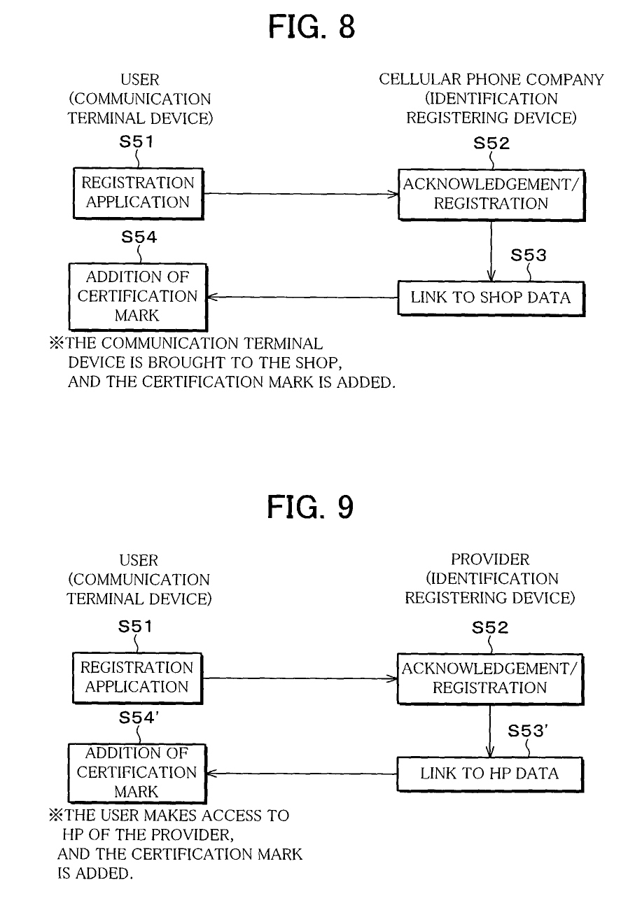

In the second place, by using FIG. 8 and FIG. 9, description is given on the following case: the cellular phone company 2 or the provider 3 examines the application of the user of the communication terminal device 10 as the examination institution, and the cellular phone company 2 or the provider 3 adds the certification mark m as the certification mark adding institution. Note that, the cellular phone company 2 or the provider 3 can warrant the identification for profit, or can warrant the identification as customer service performed by ordinary companies such as various kinds of insurance companies at low price or free of charge.

As shown in FIG. 8, if the user of the communication terminal device 10 makes an application for adding the certification mark m to a cellular phone number (S51), the cellular phone company 2 examines the application (S52). In a case where the cellular phone company 2 acknowledges the application, the cellular phone company 2 registers the communication terminal device 10 (S52), and the cellular phone company 2 instructs a shop nearest to the user to store the telephone number, to which the certification mark m has been added, in the communication terminal device 10 (S53). The shop stores the telephone number to which the certification mark m has been added (communication discrimination code 14a) in the memory section 14 of the communication terminal device 10 brought by the user (S54).

Further, as shown in FIG. 9, if the user of the communication terminal device 10 makes an application for adding the certification mark m to an e-mail address (S51), the provider 3 examines the application (S52). In a case where the provider 3 acknowledges the application, the provider 3 registers the communication terminal device 10 (S52), and the provider 3 makes a home page to store the e-mail address, to which the certification mark m has been added, in the communication terminal device 10 (S53′). When the user makes access from the communication terminal device 10 to the home page prepared by the provider 3, the e-mail address to which the certification mark m has been added (communication discrimination code 14a) is stored in the memory section 14 based on a process that has been set in the home page (S54′).

In this manner, communication companies such as the cellular phone company 2 and the provider 3 examine the application as the examination institution and add the certification mark m as the certification mark adding institution, so that a flow for actually adding the certification mark m is simplified.

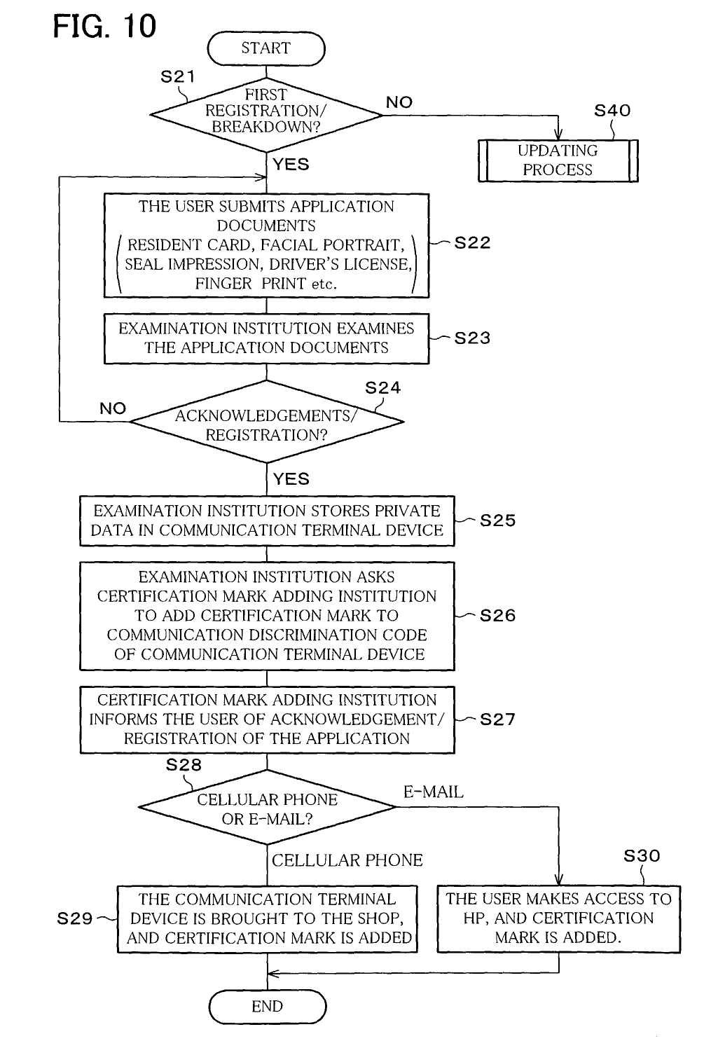

Here, referring to FIG. 10, the foregoing procedure (FIG. 6 and FIG. 7) is further detailed.

In order to receive the identification service, the user of the communication terminal device 10 makes an application to the official institution 4 or the warranty service company, that function as the examination institution, for the identification service.

In the examination institution, in a case where the certification mark m has not been added to the communication terminal device 10 due to the first registration or an accident in the communication terminal device 10 (YES in S21), the user submits a resident card, a driver's license, a national insurance card, a seal impression, a facial portrait, and a finger print as private data on which the identification is based (S22). While, in a case where the certification mark m has been added to the communication terminal device 10 (NO in S21), the step proceeds to an updating process (S40).

The examination institution examines the user of the communication terminal device 10 in accordance with the submitted private data so as to judge whether or not to add the certification mark m (S23).

In a case where the application is not acknowledged as a result of the examination (NO in S24), the user of the communication terminal device 10 makes an application for registration again after correcting problems. However, there is a case where person who may be a false user and people having no specific address may be not registered.

While, in a case where the application is acknowledged (YES in S24), the step proceeds to a process for adding the certification mark m to an e-mail address or a cellular phone number and for storing the private data.

More specifically, first, in the examination institution, the private data of the user, that is used when the examination is performed, is stored in the second memory section 17 of the communication terminal device 10 (S25).

Next, the cellular phone company 2 or the provider 3 that functions as the certification mark adding institution is asked to add the certification mark m to the e-mail address or the telephone number of the communication terminal device 10 by means of an e-mail etc. of the examination institution so as to renew the email-address or the telephone number (S26).

The certification mark adding institution asked to add the certification mark m by the examination institution confirms the asking so as to make registration with respect to the identification registering device 30 (FIG. 4 and FIG. 5), and the certification mark adding institution automatically informs the user's communication terminal device 10 that the application is acknowledged and the certification mark m is added (S27). At the same time, the cellular phone company 2 or the provider 3 makes preparation so that the user can add the certification mark m in a shop or a home page. For example, in the cellular phone company 2, data to be stored in the communication terminal device 10 is generated in a main server so as to be sent to a writing device in the shop. Further, in the provider 3, HP for certifying the communication terminal device 10 and for writing data in the communication terminal device 10 is provided.

Next, in a case where the communication discrimination code 14a to which the certification mark m is added is a telephone number of a cellular phone (cellular phone in S28), the user informed of the addition of the certification mark m by the cellular phone company 2 brings the communication terminal device 10 to a nearest shop of the cellular phone company 2 so as to store a new telephone number, to which the certification mark m has been added, in the memory section 14 by using the writing device in the shop (S29).

Furthermore, in a case where the communication discrimination code 14a to which the certification mark m is added is an e-mail address (e-mail in S28), the user informed of the addition of the certification mark m by the provider 3 makes access to the HP (home page) of the provider 3 by using the communication terminal device 10 so as to store a new e-mail address, to which the certification mark m has been added, in the memory section 14 in accordance with the HP (S30).

Note that, in a case where the cellular phone company 2 or the provider 3 is the examination institution (FIG. 8 and FIG. 9), the user of the communication terminal device 10 makes an application to the cellular phone company 2 or the provider 3. Further, in a case where the examination institution for performing the examination serves as the certification mark adding institution for adding the certification mark m, the process in which the examination institution asks the certification mark adding institution to add the certification mark m (S26) is omitted. That is, it is possible to simplify the flow of the application acknowledgement/asking for the addition of the certification mark m.

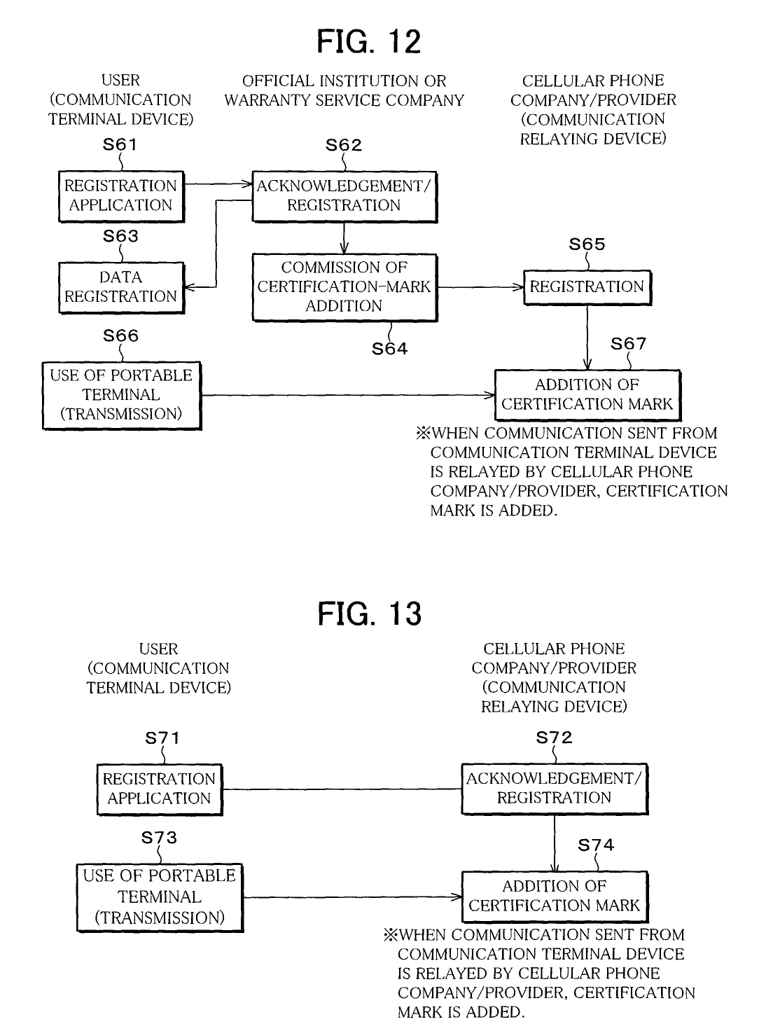

Next, referring to FIG. 12 to FIG. 14, description is given on a case where the certification mark m is added when the certification mark adding institution forwards the correspondence.

As shown in FIG. 12, if the user of the communication terminal device 10 makes an application for adding the certification mark m to a cellular phone number or an e-mail address (S61), the official institution 4 or the warranty service company 6 examines the application (S62). In a case where the application is acknowledged, the official institution 4 or the warranty service company 6 asks the cellular phone company 2 or the provider 3 to add the certification mark m (S64). Further, the communication terminal device 10 of the user is automatically informed that the application has been acknowledged and the certification mark m is to be added (S63). The cellular phone company 2 or the provider 3 registers the communication terminal device 10 to which the cellular phone company 2 or the provider 3 has been asked to add the certification mark m (S65). Further, the cellular phone company 2 or the provider 3 adds the certification mark m to the cellular phone number or the e-mail address when correspondence sent from the registered communication terminal device 10 is forwarded to a sending end (S66, S67).

Furthermore, as shown in FIG. 13, if the user of the communication terminal device 10 makes an application for adding the certification mark m to a cellular phone number or an e-mail address (S71), the cellular phone company 2 or the provider 3 examines the application (S72). In a case where the application is acknowledged, the cellular phone company 2 or the provider 3 registers the communication terminal device 10 (S72). Further, the cellular phone company 2 or the provider 3 adds the certification mark m to the cellular phone number or the e-mail address when communication sent from the registered communication terminal device 10 is forwarded to a receiver (S73, S74).

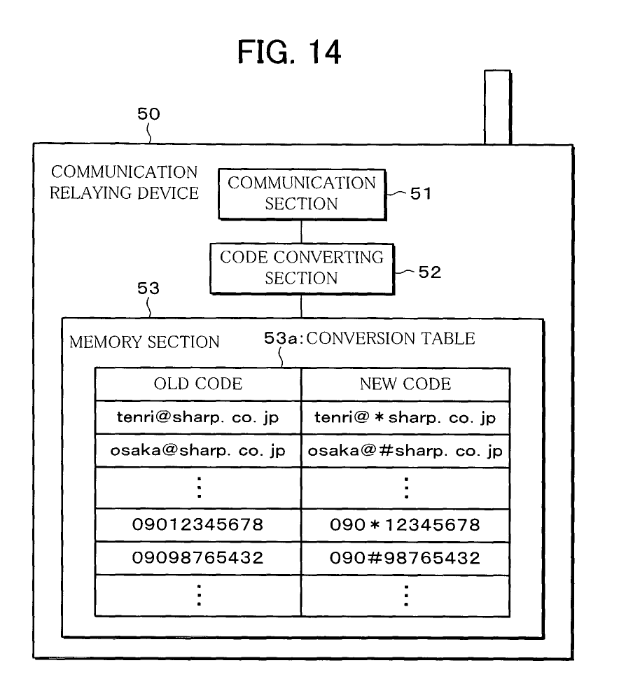

Here, FIG. 14 is a block diagram showing an example of a communication relaying device 50 for performing the process for adding the certification mark m. Note that, a conversion table 53a shown in FIG. 14 is an example, and it is possible to add the certification mark m to a cellular phone number or an e-mail address accompanied with communication data sent from the communication terminal device 10 also in other manners.

The communication relaying device 50 includes at least: a communication section (communication relaying means) 51; a code converting section (code converting means) 52; and a memory section (conversion rule storing means) 53. The communication relaying device 50 is a switching device, installed in the cellular phone company 2 or the provider 3, which relays correspondence sent from a sender to a receiver. In the communication relaying device 50, when the communication section 51 receives correspondence sent from the communication terminal device 10, the converting section 52 judges whether or not a communication discrimination code indicating a sender such as an e-mail address and a telephone number has been registered to a corresponding table (conversion table (conversion rule) 53a) of the memory section 53 as an old code. If communication discrimination code has been registered, the converting section 53 extracts a corresponding new code (second communication discrimination code), so that the communication discrimination code is rewritten so as to be forwarded.

In this manner, the addition of the certification mark m to a telephone number or an address may be performed by means of the communication relaying device 50 in the cellular phone company 2 or the provider 3. According to this manner, since the communication terminal device 10 is not subjected to any process, it is possible to reduce the trouble on the side of the user. Further, it is possible to simplify the flow for adding the certification mark m in the cellular phone company 2 or the provider 3.

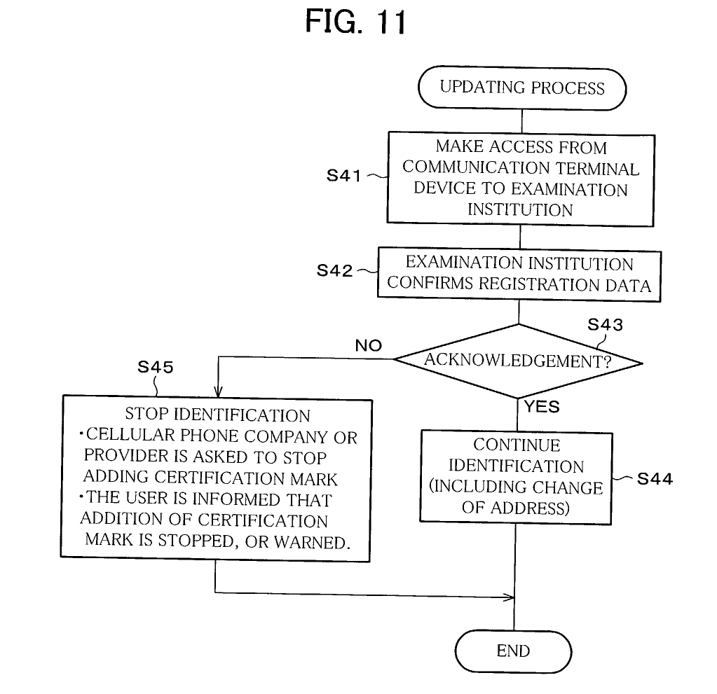

Next, FIG. 11 is a flow chart schematically showing a process for updating the identification service performed by adding the certification mark m.

It is preferable that the registration of the identification service is updated regularly or irregularly so as to keep the reliability of the certification mark m. The updating process can be performed via the Internet, or the user may directly come to the examination institution so as to be performed the updating process. Note that, it is possible to change the registration contents in the same manner as in the updating process.

In concrete terms, first, the user connects the communication terminal device 10 to the identification registering device 30 of the examination institution directly or indirectly via the Internet (S41). At this time, identical-person acknowledgement is performed in accordance with (a) the communication discrimination code 14a to which the certification mark m has been added in the communication terminal device 10 and (b) the security of a password that has been set upon registration.

Next, the examination institution confirms data registered in the database (memory section 34) in the identification registering device 30 so as to judge whether or not to allow the continuation of the registration (S32). For example, an examination is performed on whether or not the registered data is updated/changed, and whether or not the user corresponds to a false user.

If the update is accepted as a result of the examination (YES in S43), it becomes possible to use the certification mark m continuously (S44). Note that, the certification mark m may be changed upon registration.

While, in a case where the registration is not accepted (NO in S43), notification for asking the cellular phone company 2/provider 3 to stop adding the certification mark m is automatically sent by means of an e-mail etc. At the same time, a reason for which the identification service performed by adding the certification mark m is stopped (or warning of stopping the service) is automatically sent to the user by means of an e-mail etc. Further, at a time for regular update, notification for asking for the update is automatically sent to the user. In a case where the user does not update the registration for a certain period, the addition of the certification mark m is stopped in the same manner as in the foregoing process. Note that, in a case where the registration is not updated, application for re-registration may be admitted, or the re-registration may be refused.

Note that, in a case where an e-mail address or a telephone number of the communication terminal device 10 is changed, the cellular phone company 2 or the provider 3 is automatically asked to change the e-mail address or the telephone number in the same manner as in the initial registration. Further, as to changing data, data such as an address and a driver's license is changed by the identification registering device 30 of each official institution 4 etc. when notifying that the address or the driver's license has been changed. Further, when a credit card is used, it is possible to update the data by performing the examination in each business transaction at the shop 7 for example.

Furthermore, in the communication terminal device 10, the second memory section 17 can store data which has no relation to the addition of the certification mark m. For example, the official institution 4 or other institution may store the registration content or copy images of a driver's license, a national insurance card, a resident card, and the like in the second memory section 17. Further, the banking institution 5 or other institution may store data of a credit card or a cash card in the second memory section 17. The data can be displayed in the display section 13 or can be sent via the communication section 12 according to an operation of the user or according to requirement from external devices as in the data stored in the second memory section 17 by the examination institution as a base of the certification mark m.

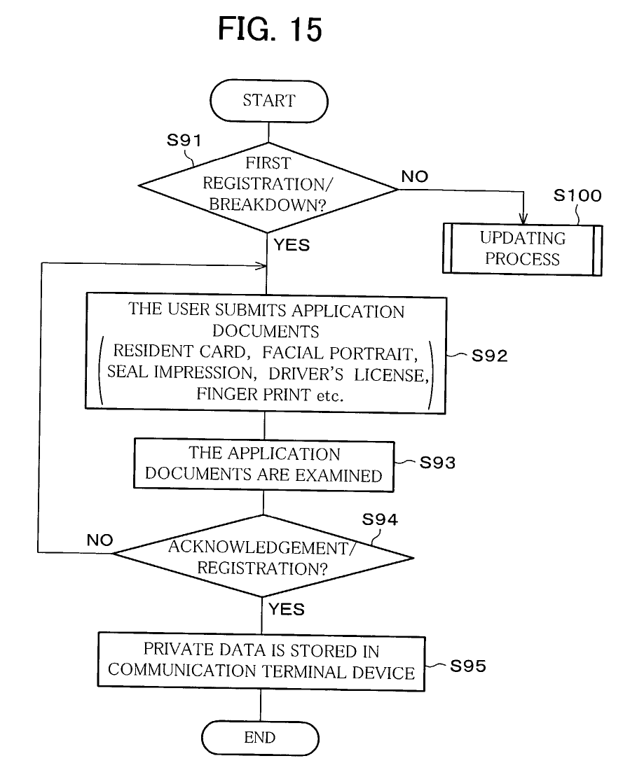

As shown in FIG. 15, a concrete procedure for storing data is the same as in the procedure in which the examination institution for adding the certification mark m performs the examination and stores the data (FIG. 10)(S91 to S95, and S100). Note that, data relating to the privacy is enciphered so as to be stored. Further, as to important data such as the official private data 17a, it is more preferable in terms of the security that the user comes to the official institution 4 etc. so as to have the data registered in the communication terminal device 10. Note that, as sufficient measures taken against the false usage, it is possible to perform the application for registration, the examination, and the registration via a registration format provided in HP of the official institution 4.

Thus, when payment is made by using a credit card whose data has been inputted to the communication terminal device 10, the identification using the certification mark m can be used. Thus, it becomes clear that the identical person uses the credit card etc., so that the reliability and the safety are improved in the business transaction. Further, in a case where money is paid later or money is paid in and out by using the communication terminal device 10, it is possible to accumulate history such as the account in the second memory section 17 of the communication terminal device 10 by performing correspondence with the shop 7 in accordance with a radio communication (Bluetooth etc.) so as to confirm the history.

Further, in the communication terminal device 10, besides the foregoing important data, data such as member's data and point data that has been conventionally provided in a form of a card can be inputted. Thus, according to the communication terminal device 10, less space is required compared with a conventional card-system, and various kinds of security function such as the security key 16 can prevent other person from false usage of the communication terminal device 10.

In this manner, according to the communication terminal device 10, in a case where the identification is required in the shop 7 or in other place, it is possible to display the certification mark m and the private data, stored in the second memory section 17 of the communication terminal device 10, directly by showing the communication terminal device 10, or in the terminal of communication opponent by means of a radio communication such as Bluetooth. Further, it is also possible to make payment etc. by the following process: a credit card and a cash card (including a debit card) are electrically registered in the communication terminal device 10 and a radio communication such as Bluetooth is used for the payment.

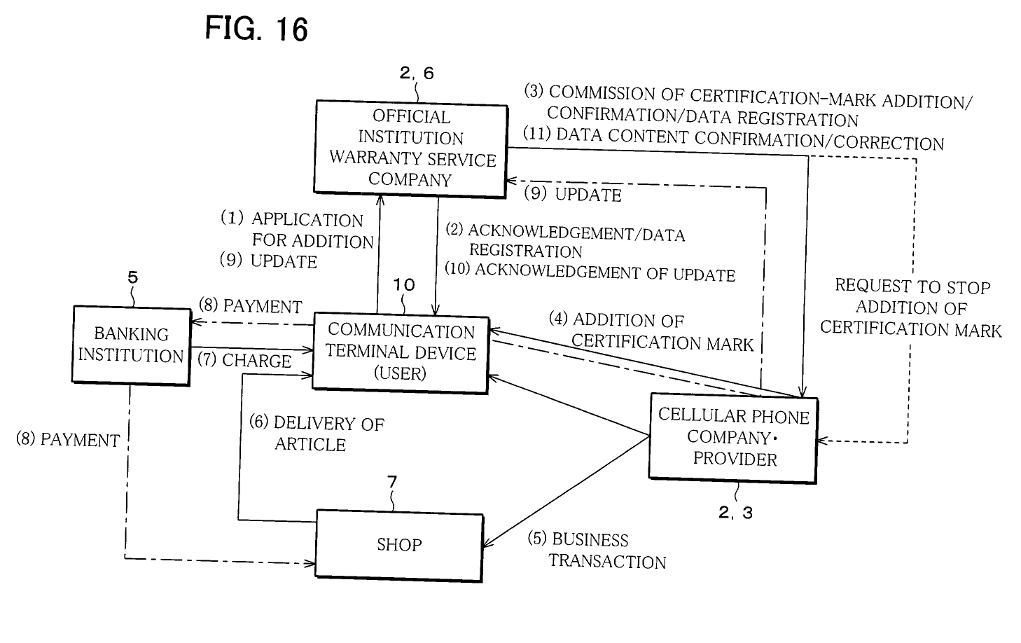

Next, referring to FIG. 16 to FIG. 22, a concrete example of a procedure of business transaction or contract using the identification service is described.

FIG. 16 is a diagram showing a procedure for performing business transaction by using the Internet or a telephone line.

First, the user of the communication terminal device 10 applies to the official institution 4 or the warranty service company 6 which functions as the examination institution for the addition of the certification mark m ((1)). Then, the examination institution acknowledges the application ((2)). At the same time, the cellular phone company 2 or the provider 3 which functions as the certification adding institution is asked to add the certification mark m ((3)). The certification mark adding institution confirms that the certification mark adding institution has been asked for the addition of the certification mark m, and adds the certification mark m to the communication terminal device 10 possessed by the user after acknowledgement ((4)).

Thereafter, the user uses the communication terminal device 10 to which the certification mark m has been added so as to perform the business transaction in the shop 7 (including a HP (home page)) via the Internet or a telephone line ((5)). At this time, (a) data such as a credit card number and (b) the communication discrimination code 14a to which the certification mark m has been added are sent from the communication terminal device 10 to the identification confirming device 70 (FIG. 1) in the shop 7. The identification confirming device 70 confirms (a) whether the certification mark m has been added or not and (b) the content of the mark so as to judge whether or not to allow the business transaction to be performed. Note that, the identification confirming device 70 of the shop 7, as shown in FIG. 1 for example, can make a balance inquiry to the banking institution 5. When the balance inquiry is made to the banking institution 5 in this manner, it is possible to perform the business transaction with the user of the communication terminal device 10 more safely.

After the business transaction is concluded, delivery of the article ((6)), charging from the banking institution 5 ((7)), and payment for the charge ((8)) are performed in the same manner as in ordinary business transaction.

Note that, the registration is updated regularly or upon changing an important matter such as an address so as to keep the reliability of the certification mark m ((9)). In a case where the private information or the certification mark m is required to be changed when the update is acknowledged ((10)), the examination institution makes the communication terminal device 10 link to the cellular phone company 2 etc. so as to change the private data or the certification mark m ((11)).

Here, unlike the business transaction performed via the Internet, in the business transaction performed via the telephone line, it is required to use a telephone provided with a display or to re-dial to confirm the certification mark m of the communication terminal device 10 by the shop 7. Further, it is required to input necessary information from the communication terminal device 10 to the identification confirming device 70 of the shop 7 according to the voice guidance.

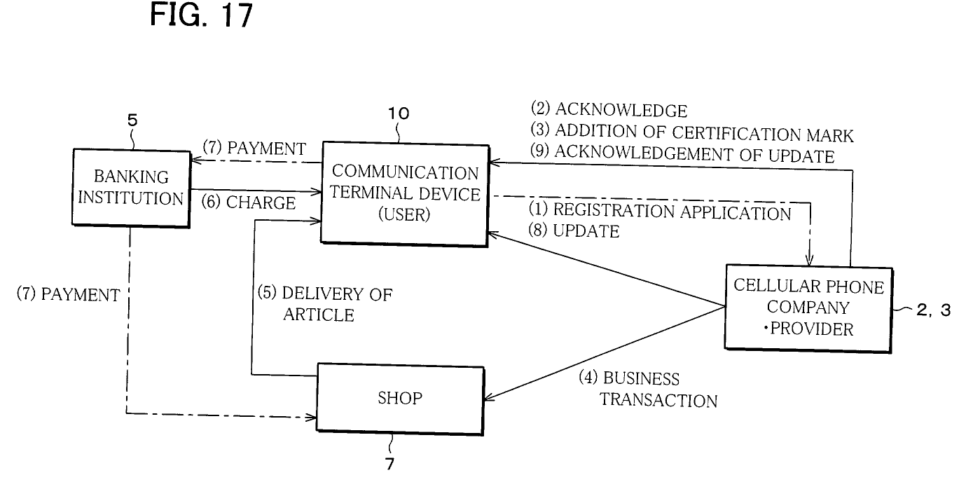

In the second place, FIG. 17 is also a diagram showing the procedure in which the business transaction is performed by using the Internet or a telephone line.

FIG. 17 is different from FIG. 16 only in that the cellular phone company 2 or the provider 3, which functions as the certification mark adding institution, serves as the examination institution. Thus, detail description thereof is omitted. In FIG. 17, the examination and the addition of the certification mark m are entirely performed by the cellular phone company 2 or the provider 3, so that the processing flow is simplified compared with FIG. 16.

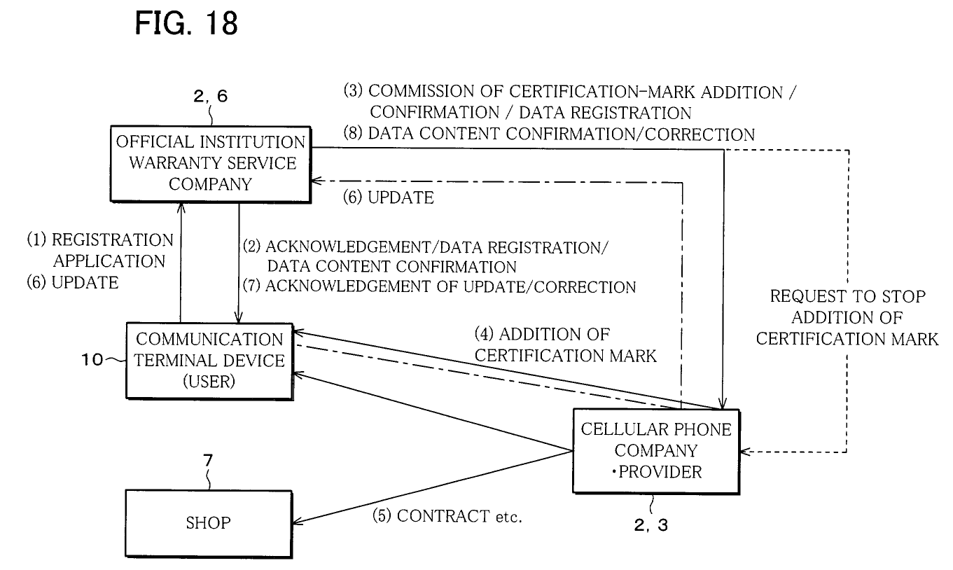

In the third place, FIG. 18 is a diagram showing a procedure in which contraction is made by using the Internet or a telephone line.

In FIG. 18, only the contraction is required, and FIG. 18 is different from FIG. 16 only in that delivery of an article and payment are not required, and a basic flow is performed in the same manner as in the business transaction. Thus, detail description thereof is omitted. Note that, contraction using a telephone line is also made in the same manner as in the business transaction of FIG. 16.

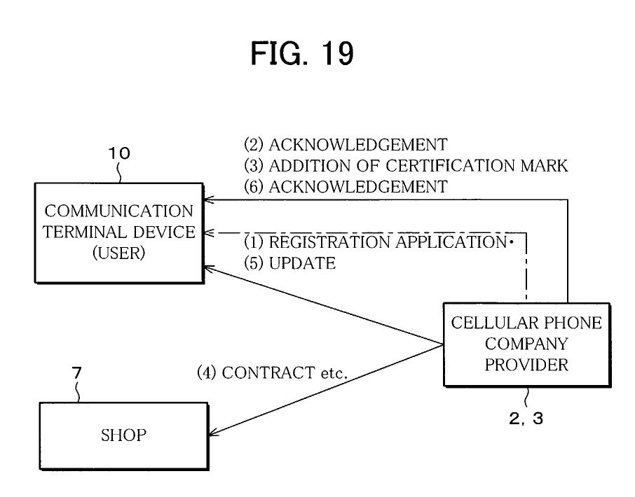

In the fourth place, FIG. 19 is also a diagram showing the procedure in which contraction is made by using the Internet or a telephone line.

FIG. 19 is different from FIG. 18 only in that the cellular phone company 2 or the provider 3, which functions as the certification mark adding institution, serves as the examination institution. Thus, detail description thereof is omitted. In FIG. 19, the examination and the addition of the certification mark m are entirely performed by the cellular phone company 2 or the provider 3, so that the processing flow is simplified compared with FIG. 18.

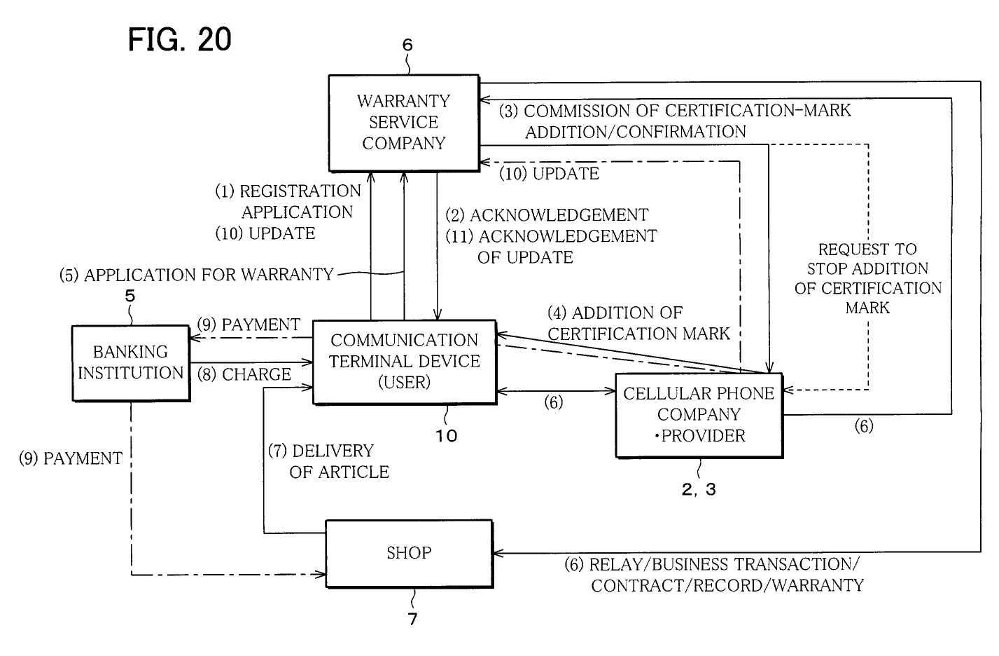

In the fifth place, FIG. 20 is a diagram showing a procedure of the following warranty intermediary service: the user makes contract for sale with the shop 7 via the warranty service company 6 by using the communication terminal device 10, so that the warranty service company 6 warrants the contract for sale.

First, the user of the communication terminal device 10 makes an application to the warranty service company 6 which functions as the examination institution for the addition of the certification mark m ((1)). Then, the warranty service company 6 acknowledges the application ((2)). At the same time, the cellular phone company 2 or the provider 3 which functions as the certification mark adding institution is asked to add the certification mark m ((3)). After the certification mark adding institution confirms that it has been asked to add the certification mark m and acknowledges the application, the certification mark adding institution adds the certification mark m to the communication terminal device 10 of the user ((4)). These processes are performed in the same manner as in FIG. 16.

Thereafter, the user makes access to HP of the warranty service company 6 via the Internet or a telephone line by using the communication terminal device 10 to which the certification mark m has been added, and inputs necessary information, so as to make an application for the warranty intermediary service ((5)). The warranty service company 6 examines and checks (a) whether the communication discrimination code 14a has the certification mark m or not, and (b) a condition of the shop 7 with which the user is to perform the business transaction. In a case where it is possible to warrant the business transaction, the warranty service company 6 allows, via the HP of the warranty service company 6, the communication terminal device 10 to connect to HP of the desired shop 7.

After the communication terminal device 10 is connected to the HP of the shop 7, the shop 7 examines and checks (a) an address of the warranty service company 6, (b) whether or not the certification mark m of the user has been added, and (c) the content of the certification mark m (whether the user is underage person or not etc.) so as to perform the business transaction. After the shop 7 accepts the business negotiation and the contract, “purchase-and-sale/contraction confirmation” is sent from the shop 7, and the user confirms the “purchase-and-sale/contraction confirmation”. In a case where there occurs no problem, the user sends “acceptance” via the warranty service company 6 by using the Internet again. In this manner, the business negotiation and contraction are completed. During this time, the warranty service company 6 records the content of the contraction ((6)), and performs various kinds of warranty in a case where a trouble occurs, and notifies the police in a case where false usage etc. is brought to light. Thus, it is possible to realize high-security business transaction and contract of membership registration etc.

After the business transaction is completed, delivery of the article ((7)), charging from the banking institution 5 ((8)), and payment for the charge ((9)) are performed in the same manner as in ordinary business transaction. Further, the registration is updated regularly or in the case where important data such as an address is changed ((10)), so as to keep the reliability of the certification mark m. In a case where the private information or the certification mark m is required to be changed when the update is acknowledged ((11)), the examination institution makes the communication terminal device 10 link to the cellular phone company 2 etc. so as to change the private data or the certification mark m.

Here, in the business transaction performed via HP of the warranty service company 6 by the user using the certification mark m, the warranty service company 6 which performs the foregoing intermediary warranty service warrants an article in a case where the article is not delivered, and warrants charge in a case where the charge is not paid, and acts as an intermediary in a case where there occurs any problem with respect to various kinds of contract. Further, the user of the communication terminal device 10 may use the warranty service company 6, and the shop 7 which functions as a seller may use the warranty service company 6 by contraries. Of course, both the user and the shop 7 may use the warranty service company 6. The warranty service company 6 can determine (a) a list of charges, (b) various kinds of the examination content, and (c) whether the warranty can be performed or not, by supposing a case where only the user has the certification mark m and a case where both the user of the communication terminal device 10 and the shop 7 have the certification mark m. The warranty service company 6 can provide the warranty service either with it charged or free of charge arbitrarily.

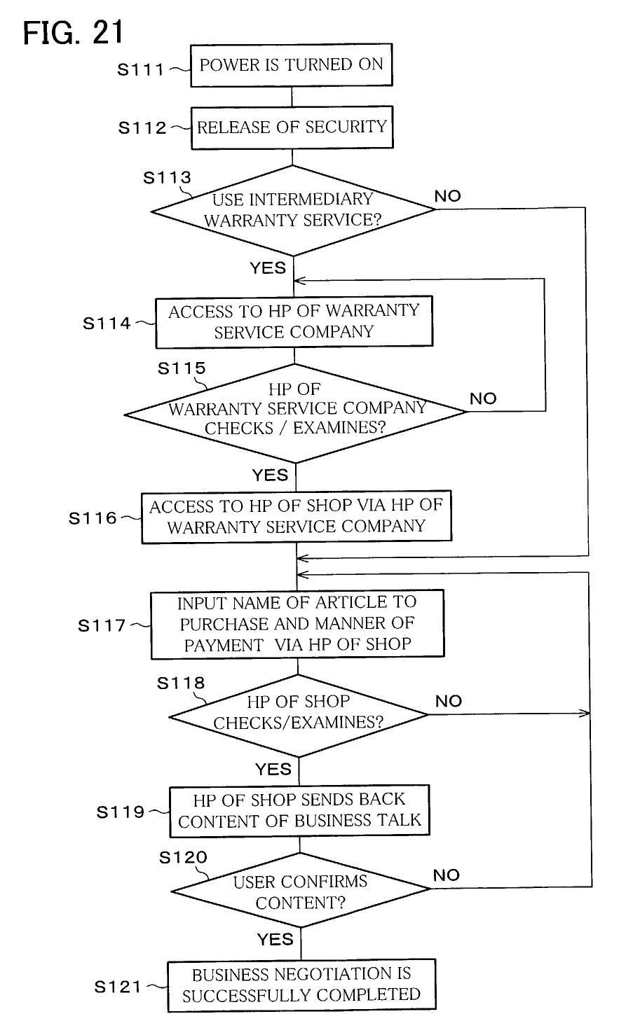

FIG. 21 is a flow chart in a case where the intermediary warranty service is used by using the communication terminal device 10.

First, the user of the communication terminal device 10 turns on the communication terminal device 10 so as to activate the communication terminal device 10 (S111). Thereafter, the user unlocks the security lock so that the certification mark m can be sent from the communication terminal device 10 by installing the security key 16 into the communication terminal device 10 (S112).

Thereafter, in a case where the intermediary warranty service is used (YES in S113), the user makes access to HP of the warranty service company 6 so as to input necessary information (S114). Then, if the user passes the examination (YES in S115), the user makes access to HP of the desired shop 7 via a server device of the warranty service company 6 (S116). Note that, in a case where the intermediary warranty service is not used (NO in S113), the user makes access directly to the HP of the desired shop 7.

With respect to the HP of the shop 7, the user sends a name of a selected article and a payment method from the communication terminal device 10 (S117). In response to this, in the HP of the shop 7, checking and examination are performed on whether or not the certification mark m has been added to an address etc. of the communication terminal device 10. When the user passes the examination (YES in S118), the business transaction begins. The shop 7 confirms the contract content of the business transaction so as to send the contract content to the communication terminal device 10 (S119). If the user accepts the contract content (YES in S120), the business negotiation is completed (S121).

Note that, the intermediary warranty service using a telephone is performed basically in the same manner as in the foregoing process. However, the intermediary warranty service using a telephone is different in that (a) necessary information is inputted according to a voice guidance and (b) autograph information includes voice information.

Furthermore, in the intermediary warranty service, both the user of the communication terminal device 10 and the shop 7 may have the certification mark m. In this case, the warranty service company 6 can examine and check whether it is possible to warrant the contract or not in accordance with (a) data which the user of the communication terminal device 10 has inputted in HP of the warranty service company 6, (b) the certification mark m, (c) data such as a credit card number inputted in HP of the shop 7, and (d) the certification mark m of the shop 7. In this manner, in the case where both the user and the shop 7 have the certification mark m, both the user and the shop 7 can be identified clearly, so that there is small risk in warranting the contract. That is, it is easy for the warranty service company 6 to collect the cash and it is possible for the warranty service company 6 to cope with problems in a case where false usage is brought about.

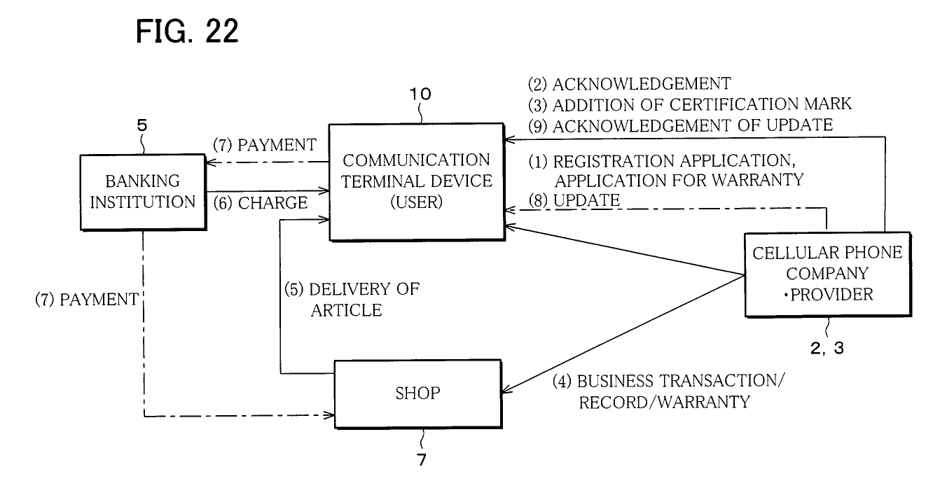

Furthermore, as shown in FIG. 22, not only the warranty service company 6 but also the cellular phone company 2 or the provider 3 may perform the intermediary warranty service. In this case, the cellular phone company 2 or the provider 3 entirely performs the process, so that the processing flow can be simplified.

Furthermore, in the foregoing description, although it is assumed that the user of the communication terminal device 10 is a personal user, also a company can obtain the certification mark m. In this case, it is possible to add the certification mark m to a specific data managing device (server), so that the reliability and the safety in the business transaction and various kinds of contract are improved.

Furthermore, according to the identification service using the certification mark m, it is possible to control access that is externally made, in accordance with the certification mark m. That is, a receiver such as the shop 7 can automatically judge whether the communication terminal device 10 can be connected to the receiver or not in accordance with (a) whether the communication terminal device 10 has the certification mark m or not and (b) type of the certification mark m.

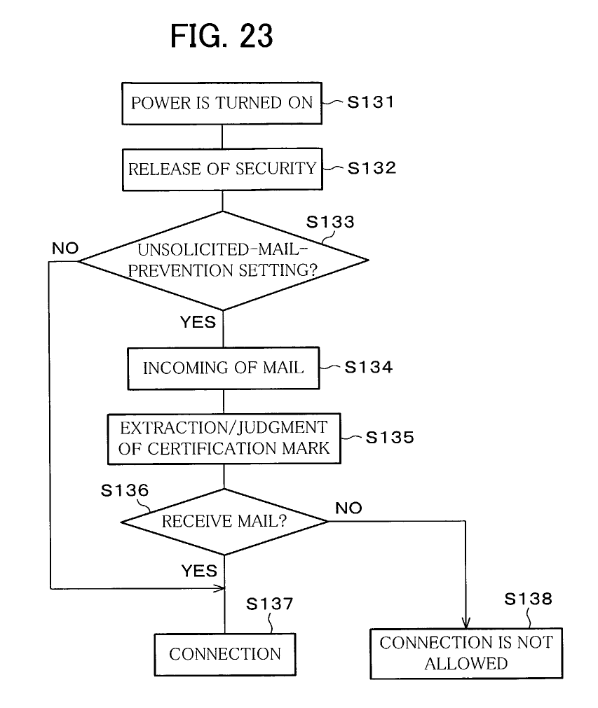

For example, according to the identification service, it is possible to prevent reception of an unsolicited mail on which various disputes are currently raised. Concretely, as shown in FIG. 23, the communication terminal device 10 is turned on (S131). After the security lock is unlocked (S132), setting is performed with respect to mail reception (YES in S133). At this time, if setting is performed so that “only the mail having the certification mark m is received”, judgment is given on whether a mail has the certification mark m or not (S135) upon receiving the mail (S134), so as to determine whether or not prevent the communication terminal device 10 from being externally connected (S136 to S138). Thus, whether or not to prevent the communication terminal device 10 from being externally connected is automatically determined, so that it is possible to prevent the reception of the unsolicited mail.

Furthermore, it is possible to prevent underage person from making access to an adult site (for example, meet-a-mate site). Concretely, this is realized by providing a filter function which accepts only access from the communication terminal device 10 having an adult certification mark m. Thus, it is possible to prevent access to the adult site from the underage person's communication terminal device 10 having no adult certification mark m.

Here, it is possible to arrange the communication terminal device 10 and the identification confirming device 70 by using a portable data terminal such as a cellular phone and a PDA (personal digital assistant) or a general-purpose computer such as a personal computer as a base. That is, in the present embodiment, the description is given by supposing that the communication terminal device 10 is a portable communication terminal device, but a non-portable device such as a desk top type computer may be used as the communication terminal device 10. Further, it is possible to arrange the identification registering device 30 and the communication relaying device 50 by using a work station and a general-purpose computer such as a personal computer as a base. Note that, each of the communication terminal device 10, the identification confirming device 70, the identification registering device 30, and the communication relaying device 50 may be arranged by combining a plurality of devices.

That is, the communication terminal device 10, the identification registering device 30, the communication relaying device 50, and the identification confirming device 70 each include a CPU (central processing unit) executing instructions in the program implementing associated functions; a ROM (read only memory) storing a boot logic; a RAM (random access memory) into which the program is loaded; a hard disk ROM or other similar storage device (storage medium) storing the program and various databases; a keyboard, mouse, and other input devices; a monitor LCD, CRT, speaker, printer, and other output devices; and a network connecting device which establishes connection to an external network, with all these components interconnected by an internal bus.

Further, those functions of the communication terminal device 10, the identification registering device 30, the communication relaying device 50, and the identification confirming device 70 are all provided by loading programs from the storage device to the RAM when necessary for execution by the CPU.

Furthermore, in the present embodiment, the description is given by using mainly the cellular phone and the e-mail as examples, but the present invention is not limited to the examples. That is, a transmission medium used in communication among the communication terminal device 10, the identification registering device 30, the communication relaying device 50, and the identification confirming device 70 is not limited. Concretely, as a transmission medium, a physical (wired) line such as an IEEE1394, a USB, a power-line carrier, a cable TV line, a telephone line, and an ADSL line may be used, and infrared rays such as an IrDA and a remote control, and a radio line such as Bluetooth, a 802.11 radio line, an HDR, a cellular phone network, a satellite line, and a ground wave digital network may be used.

Lastly, the objectives of the present invention can be achieved by feeding into a device or system a storage medium which stores, in a computer-readable manner, program code (execution program, intermediate code program, source program) of an identification program which is software implementing the aforementioned functions, and by causing a computer (alternatively CPU or MPU) in the device or system to read out and execute the program code stored in the storage medium. In this case, the program code read from the storage medium themselves implements the aforementioned functions, and the storage medium storing the program code constitutes the present invention.

Concretely, a microprocessor etc. executes predetermined program stored in a memory (not shown) of the communication terminal device 10, so that the control section 11 (including the checking section 11a) provided in the communication terminal device 10 (FIG. 4) is realized. Further, a microprocessor executes predetermined program stored in a memory (not shown) of the identification registering device 30, so that the control section 31 (including the checking section 31a and the enciphering section 31b) provided in the identification registering device 30 (FIG. 4) is realized. Further, a microprocessor executes predetermined program stored in a memory (not shown) of the identification confirming device 70, so that the control section 71 (including the checking section 71a) provided in the identification confirming device 70 (FIG. 1) is realized. Further, a microprocessor executes predetermined program stored in a memory (not shown) of the communication relaying device 50, so that the code converting section 52 provided in the communication relaying device 50 (FIG. 14) is realized.

The storage medium to feed the program code can be adapted to be separable from a system or device. Also, the storage medium may be a medium which holds the program code in fixed manner so that the storage medium can feed the program code. Further, the storage medium may be of such a type that is connected to a system or device so that the stored program code can be directly read out by a computer or of such a type that is connected so as to be readable via a program reader connected to the system or device as an external storage device.

Examples of the storage medium include tapes, such as magnetic tape and cassette tape; disks including magnetic disks, such as floppy disks and hard disk, and optical disks, such as CD-ROMs, MOs, MDs, DVDs, and CD-Rs; cards, such as IC card (including memory cards) and optical cards; and semiconductor memories, such as mask ROMs, EPROMs, EEPROMs, and flash ROMs.

The program code may be stored in such a manner that a computer can read the program code from a storage medium for direct execution or in such a manner that the program code is transferred from a storage medium to a program memory area in a main memory before a computer reads from the main memory for execution.

The system or device may be adapted to be connectable to a communications network (including the Internet, an intranet, etc.) to feed the program code over the communications network.

Note that it is supposed that a program for reading the aforementioned program code from a storage medium for loading into a main memory and a program for downloading the aforementioned program code from the communications network are both stored in advance in a system or device so as to be executable by a computer.

The aforementioned functions can be implemented not only by executing the aforementioned program code read out by a computer, but also by means of, for example, an OS which runs on the computer and entirely or partly executes an actual process based on an instruction in the program code.

The aforementioned functions can be implemented also by means of for example, a CPU which is provided in a function extension board provided in a computer or a function extension unit connected to a computer for entire or partial execution of an actual process based on an instruction in the program code after the program code read from a storage medium is written to a memory in the function extension board or the function extension unit.

As described above, the identifying method of the present invention includes the steps of: performing a certification mark adding process for adding a certification mark, that identifies a user of a sending device, to a communication discrimination code that the sending device sends as data indicating a sender; and performing a certification mark extracting process for extracting the certification mark from the communication discrimination code that is received by a receiving device.

Thus, it is possible to indicate and confirm the identification easily.

Further, the identifying method of the present invention may include the step of performing a certification mark storing process for storing the communication discrimination code, to which the certification mark has been added, in the sending device in advance, wherein the communication discrimination code that has been stored in the certification mark storing process is obtained and is sent in the certification mark adding process.

According to the arrangement, when the communication discrimination code is sent from the sending device, the communication discrimination code that has been stored in the sending device in advance can be read out so as to be sent. Thus, it is possible to send the communication discrimination code, to which the certification mark has been added, in accordance with the same procedure as a conventional procedure for sending a telephone number or an e-mail address in sending the telephone number or the e-mail address. Thus, the user of the sending device who is a sender can indicate the certification mark, which identifies the user, without performing a special operation.

Note that, in order to keep the reliability of the certification mark, it is desirable to store the communication discrimination code so that the user of the sending device cannot rewrite the communication discrimination code.

Further, the identifying method of the present invention may include the step of performing a communication relaying process for causing a communication relaying device to receive the communication discrimination code sent from the sending device so as to send the communication discrimination code to the receiving device, wherein: in the certification mark adding process, the certification mark is added to the communication discrimination code when the communication discrimination code is relayed in the communication relaying device in accordance with the communication relaying process.

According to the arrangement, the communication relaying device performs the process for adding the certification mark to the communication discrimination code which identifies the user of the sending device. That is, the communication discrimination code having no certification mark is sent from the sending device regardless of whether or not to add the certification mark. Thus, it is possible to send the communication discrimination code, to which the certification mark has been added, in accordance with the same procedure as a conventional procedure for sending a telephone number or an e-mail address in sending the telephone number or the e-mail address. Thus, the user of the sending device who is a sender can indicate the certification mark, which identifies the user, without performing a special operation.

Further, the identifying method of the present invention may be arranged so that the certification mark extracting process is performed by the receiving device.

According to the method, compared with the case where the certification mark extracting process is performed by other device for example, it is not necessary to send the communication discrimination code to the other device, so that it is possible to confirm the identification more quickly and securely.

Further, the identifying method of the present invention may include the step of performing a code sending process in which the communication discrimination code that has been received by the receiving device is sent to a banking institution, wherein the certification mark extracting process is performed by the banking institution.

According to the method, compared with the case where the certification mark extracting process is performed by the receiving device for example, it is not necessary to perform the certification mark extracting process by means of the receiving device, so that it is possible to simplify the arrangement of the receiving device. Thus, according to the arrangement, it is possible to realize the identifying method more easily.

Further, the identifying method of the present invention may be arranged so that: in the certification mark adding process, an identification code, corresponding to the communication discrimination code, that complements the certification mark, is added to the communication discrimination code in combination with the certification mark, and in the certification mark extracting process, the identification code as well as the certification mark is extracted from the communication discrimination code that is received by the receiving device.

Here, examples of the content of the identification code include a name, age, gender, an address of the user, a certification mark, a name of an examination institution, a name of a certification mark adding institution, classification of private data on which the identification is based, a lank of the identification, and a period of validity.

According to the method, the user of the sending device who is a sender can indicate the identification code without performing a special operation. While, the receiver on the side of the receiving device can more steadily confirm the identification of the sender by extracting also the certification mark from the communication discrimination code that has been received.

Further, according to the arrangement, in a case where one device is used as the sending device and the receiving device for example, the user of the sending device can indicate the identification code by using the sending device at the shop. Thus, it is possible to ensure the identification.

Further, the identifying method of the present invention may include the step of performing a balance inquiry to a banking institution in accordance with the communication discrimination code that has been received by the receiving device.

According to the method, when the balance inquiry is made to the banking institution, for example, it is possible to perform the business transaction with the user of the sending device safely.

Further, an identification program of the present invention is a computer program for causing a computer to carry out the foregoing processes.

According to the arrangement, the computer is made to perform the respective processes, so that it is possible to carry out the identifying method. Thus, it is possible to obtain the effect brought about by the identifying method, that is, the identification can be easily indicated and confirmed.

Further, a computer-readable storage medium of the present invention, which stores the identification program for carrying out the identifying method, causes a computer to carry out the respective processes.

According to the arrangement, the identifying method can be carried out in accordance with the identification program read out from the storage medium.

Further, the sending device of the present invention includes: storing means for storing the communication discrimination code to which the certification mark for identifying the user of the sending device is added; and sending means for obtaining the communication discrimination code from the storing means as data indicating a sender, and for sending the communication discrimination code.

According to the arrangement, when the communication discrimination code is sent from the sending device, it is possible to read the communication discrimination code, that has been stored in the storing means of the sending device in advance, so as to send the communication discrimination code. Thus, it is possible to send the communication discrimination code, to which the certification mark has been added, in accordance with the same procedure as a conventional procedure for sending a telephone number or an e-mail address in sending the telephone number or the e-mail address. Thus, the user of the sending device who is a sender can indicate the certification mark, which identifies the user, without performing a special operation. That is, it is possible to indicate the identification easily.

Note that, in order to keep the reliability of the certification mark, it is desirable to store the communication discrimination code so that the user of the sending device cannot rewrite the communication discrimination code.

Furthermore, the sending device of the present invention may include acknowledging means for acknowledging a user of the sending device and for forbidding the use of the sending device by person other than a regular user.

According to the arrangement, it is possible to prevent such a problem that: other person pretends to be the regular user so as to perform communication via the sending device by using the communication discrimination code to which the certification mark has been added. Here, it is desirable to combine plural security functions such as (a) various kinds of identification acknowledgement including a password and (b) a security key separable from the sending device so as to use the functions as the acknowledging means.

Further, the sending device of the present invention is arranged so that the storing means stores an identification code, corresponding to the communication discrimination mark, that complements the certification code in combination with the communication discrimination code.

According to the arrangement, the communication discrimination code that has been sent by the sending device is received by the receiving device, and the identification code is extracted in combination with the certification mark. Thus, the user of the sending device who is a sender can indicate the identification code which complements the certification mark. Thus, it is possible to indicate and confirm the identification easily.

Further, the sending device of the present invention is arranged so that the storing means allows writing of the communication discrimination code only by predetermined competent person.

According to the arrangement, only the predetermined competent person can write the communication discrimination code, and the communication discrimination code is stored so as not to be rewritten by the user of the sending device, so that it is possible to keep the reliability of the certification mark.

Further, a receiving device of the present invention includes: receiving means for receiving a communication discrimination code indicating a sender; and extracting means for extracting a certification mark, used to identify a user of a sending device who is the sender, from the communication discrimination code.

According to the arrangement, the receiving device receives the communication discrimination code to which the certification mark has been added so as to identify the user of the sending device as data indicating a sender, and the certification mark is extracted from the communication discrimination code. Thus, the receiver on the side of the receiving device can confirm the identification of the sender only by extracting the certification mark from the communication discrimination code that has been received. Thus, it is possible to confirm the identification easily.

Further, a communication relaying device of the present invention includes: communication relaying means for receiving a communication discrimination code, that is sent from a sending device, and for sending the communication discrimination code to a receiving device; conversion rule storing means for storing a conversion rule by which the communication discrimination code is converted into a second communication discrimination code to which the certification mark to identify a user of the sending device is added; and code converting means for converting the communication discrimination code into the second communication discrimination code corresponding to the communication discrimination code when the communication relaying means relays the communication discrimination code.

According to the arrangement, the communication relaying device performs the process for adding the certification mark, which identifies the user of the sending device, to the communication discrimination code. Thus, the communication discrimination code having no certification mark is sent from the sending device regardless of whether or not to add the certification mark. Therefore, it is possible to send the communication discrimination code to which the certification mark has been added in accordance with the same procedure as a conventional procedure for sending a telephone number or an e-mail address in sending the telephone number or the e-mail address. Thus, the user of the sending device who is a sender can indicate the certification mark, which identifies the user, without performing a special operation.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. An identifying method comprising the steps of:
performing a certification mark adding process for adding a certification mark, that identifies a user of a sending device, to a communication discrimination code that the sending device sends as data indicating a sender; and
performing a certification mark extracting process for extracting the certification mark from the communication discrimination code that is received by a receiving device.

2. The method as set forth in claim 1, further comprising the step of performing a certification mark storing process for storing the communication discrimination code, to which the certification mark has been added, in the sending device in advance, wherein
the communication discrimination code that has been stored in the certification mark storing process is obtained and is sent in the certification mark adding process.

3. The method as set forth in claim 1, further comprising the step of performing a communication relaying process for causing a communication relaying device to receive the communication discrimination code sent from the sending device so as to send the communication discrimination code to the receiving device, wherein:
in the certification mark adding process, the certification mark is added to the communication discrimination code when the communication discrimination code is relayed in the communication relaying device in accordance with the communication relaying process.

4. The method as set forth in claim 1, wherein the certification mark extracting process is performed by the receiving device.

5. The method as set forth in claim 1, further comprising the step of performing a code sending process in which the communication discrimination code that has been received by the receiving device is sent to a banking institution, wherein
the certification mark extracting process is performed by the banking institution.

6. The method as set forth in claim 1, wherein:
in the certification mark adding process, an identification code, corresponding to the communication discrimination code, that complements the certification mark, is added to the communication discrimination code in combination with the certification mark, and
in the certification mark extracting process, the identification code as well as the certification mark is extracted from the communication discrimination code that is received by the receiving device.

7. The method as set forth in claim 1, further comprising the step of performing a balance inquiry to a banking institution in accordance with the communication discrimination code that has been received by the receiving device.

8. An identification program for carrying out an identifying method,
the method including the steps of: performing a certification mark adding process for adding a certification mark for identifying a user of a sending device to a communication discrimination code that the sending device sends as data indicating a sender; and performing a certification mark extracting process for extracting the certification mark from the communication discrimination code that is received by a receiving device,
the identification program being a computer program for causing a computer to carry out the certification mark adding process and the certification mark extracting process.

9. A computer-readable storage medium which stores an identification program for carrying out an identifying method,
the method including the steps of: performing a certification mark adding process for adding a certification mark for identifying a user of a sending device to a communication discrimination code that the sending device sends as data indicating a sender; and performing a certification mark extracting process for extracting the certification mark from the communication discrimination code that is received by a receiving device,
the identification program being a computer program for causing a computer to carry out the certification mark adding process and the certification mark extracting process.

10. A sending device comprising:
storing means for storing the communication discrimination code to which the certification mark for identifying the user of the sending device is added; and
sending means for obtaining the communication discrimination code as data indicating a sender from the storing means, and for sending the communication discrimination code.

11. The sending device as set forth in claim 10, further comprising acknowledging means for acknowledging a user of the sending device and for forbidding the use of the sending device by person other than a regular user.

12. The sending device as set forth in claim 10, wherein the storing means stores an identification code, corresponding to the communication discrimination code, that complements the certification mark in combination with the communication discrimination code.

13. The sending device as set forth in claim 10, wherein the storing means allows writing of the communication discrimination code only by predetermined competent person.

14. A receiving device comprising:
receiving means for receiving a communication discrimination code indicating a sender; and
extracting means for extracting a certification mark, used to identify a user of a sending device who is the sender, from the communication discrimination code.

15. A communication relaying device comprising:
communication relaying means for receiving a communication discrimination code, that is sent from a sending device, and for sending the communication discrimination code to a receiving device;
conversion rule storing means for storing a conversion rule by which the communication discrimination code is converted into a second communication discrimination code to which the certification mark for identifying a user of the sending device is added; and
code converting means for converting the communication discrimination code into the second communication discrimination code corresponding to the communication discrimination code when the communication relaying means relays the communication discrimination code.
